(19) United States
(12) Patent Application Publication
(10) Pub. No.: US 2016/0105613 A1
(43) Pub. Date: Apr. 14, 2016

(54) LENS UNIT, METHOD FOR CONTROLLING LENS UNIT, IMAGING APPARATUS, AND METHOD FOR CONTROLLING IMAGING APPARATUS

(71) Applicant: CANON KABUSHIKI KAISHA, Tokyo (JP)

(72) Inventor: Hideya Takanashi, Tokyo (JP)

(21) Appl. No.: 14/877,382

(22) Filed: Oct. 7, 2015

(30) Foreign Application Priority Data
Oct. 9, 2014 (JP) 2014-208409

(51) Int. Cl. H04N 5/232; H04N 5/225; G02B 7/14

(52) U.S. Cl. CPC H04N 5/23293; G02B 7/14; H04N 5/2254

(57) ABSTRACT

A lens unit that can be attached to an imaging apparatus includes a display unit configured to switch and display information of a plurality of items, a lens control unit configured to control display on the display unit, and a first storage unit configured to store first information indicating an item selected from among items of information that can be displayed on the display unit. When the display on the display unit is turned off, the lens control unit stores in the first storage unit the first information corresponding to an item of information displayed on the display unit, and when the display on the display unit is turned on, the lens control unit displays, on the display unit, information of the item indicated by the first information stored in the first storage unit.

### BACKGROUND OF THE INVENTION

1. Field of the Invention

The present invention relates to an interchangeable lens unit and an imaging apparatus in an interchangeable lens system.

2. Description of the Related Art

Conventionally, a member including a lens barrel portion is mounted on an interchangeable lens that can be attached to an interchangeable lens camera. On the outer periphery of the lens barrel portion, distance graduations, focal length graduations, and angle-of-view information are printed so that the setting state of the current lens can be confirmed at a glance. In a method using a member on which such information is printed, only particular information printed in advance can be displayed.

Meanwhile, there is a wide variety of usage of a camera, such as a photographing mode. Thus, it is assumed that information required for photographing varies depending on the photographing situation. In response, to improve usability for a user, a technique for enabling the dynamic switching of the display contents of a lens is discussed.

The Japanese Patent Application Laid-Open No. 2007-72407 discusses a configuration in which a display unit using electronic paper or a liquid crystal display is mounted on a lens barrel and displays distance information of a currently set interchangeable lens. According to the Laid-Open No. 2007-72407, if the electronic paper is used for the display of a lens, it is possible to maintain the display without the supply of power. Further, in the Japanese Patent Application Laid-Open No. 2007-72407, it is possible to optionally switch display items, for example, between a focal length, an object distance, a diaphragm value, and angle-of-view information of a lens.

It is assumed that, when photographing is performed using a lens having an information display function as described above, a user powers off the camera or interchanges lenses in the middle of the photographing. In view of convenience for the user, it is desirable that when the camera is started up after the camera is powered off or lenses are interchanged, information of the same item as previously displayed should be displayed on the lens. For example, it is assumed that, if information about the focal length is displayed on the lens before the interchange, the user confirms information about the focal length of the lens even after the interchange.

In the Japanese Patent Application Laid-Open No. 2007-72407, however, if the supply of power to the lens is disconnected, it may be possible to merely maintain display on the electronic paper. When, however, power is supplied to the lens next, display data is generated based on a predetermined item and the generated displayed data is displayed on the lens. That is, the Japanese Patent Application Laid-Open No. 2007-72407 does not discuss a method for displaying information on the lens at the next start-up using the same item as displayed before the supply of power is disconnected. Thus, every time the user performs the operation of interchanging lenses or powering off the camera, the user needs to perform the operation of switching the displayed information item to a desired item.

Further, if all items of information are simultaneously displayed to eliminate the need for switching display items, the processing load for generating information to be displayed increases. This may hinder timely display.

### SUMMARY OF THE INVENTION

The present invention is directed to an interchangeable lens system using a lens having an information display function, which enables display of information on a lens that is more convenient for a user.

According to an aspect of the present invention, a lens unit that can be attached to an imaging apparatus includes a display unit configured to switch and display information relating to a plurality of items, a lens control unit configured to control the display on the display unit, and a first storage unit configured to store first information indicating an item selected from among items of information that can be displayed on the display unit. When the display on the display unit is turned off, the lens control unit stores in the first storage unit the first information corresponding to an item of information displayed on the display unit, and when the display on the display unit is turned on, the lens control unit displays on the display unit the information relating to the item indicated by the first information stored in the first storage unit.

According to another aspect of the present invention, a lens unit that can be attached to an imaging apparatus includes a display unit configured to switch and display information relating to a plurality of items, a lens control unit configured to exchange information in communication with the imaging apparatus and control the display on the display unit, and a first storage unit configured to store first information indicating an item selected from among items of information that can be displayed on the display unit, wherein based on information received from the imaging apparatus, the lens control unit switches between display and non-display, on the display unit, of information relating to the item corresponding to the first information stored in the first storage unit.

According to yet another aspect of the present invention, an imaging apparatus to which a lens unit including a display unit configured to switch and display information relating to a plurality of items can be attached includes a control unit configured to exchange information in communication with the lens unit and transmit to the lens unit an instruction regarding the display on the display unit, and a second storage unit configured to store information received from the lens unit. The control unit receives, from a lens unit attached to the imaging apparatus, first information indicating an item selected from among items of information that can be displayed on the display unit, and stores the received first information in the second storage unit. The control unit further transmits, to a lens unit attached to the imaging apparatus, the instruction regarding the display on the display unit based on the first information stored in the second storage unit.

Further features of the present invention will become apparent from the following description of exemplary embodiments with reference to the attached drawings.

### BRIEF DESCRIPTION OF THE DRAWINGS

FIG. 1 is a block diagram illustrating an interchangeable-lens camera system according to a rendition of the present exemplary embodiments.

FIG. 2 is a diagram illustrating a configuration of a lens unit according to a rendition of the present exemplary embodiments.

FIG. 3 is a diagram illustrating an example of display state information that can be switched and is displayed on a lens display unit according to a rendition of the present exemplary embodiments.

FIG. 4 is a flowchart illustrating processing performed when an operation of the lens unit is started, according to an exemplary embodiment.

FIG. 5 is a flowchart illustrating processing performed when an operation of a camera is started, according to an exemplary embodiment.

FIG. 6 is a flowchart illustrating processing performed when the operation of the lens unit is started, according to an exemplary embodiment.

FIGS. 7A and 7B are flowcharts illustrating processing performed during the operations of the camera and the lens unit according to an exemplary embodiment.

FIGS. 8A and 8B are flowcharts illustrating processing performed when the camera and the lens unit are powered off, according to an exemplary embodiment.

FIG. 9 is a diagram illustrating an example of a format of a list indicating display state information that can be displayed on the lens display unit.

### DESCRIPTION OF THE EMBODIMENTS

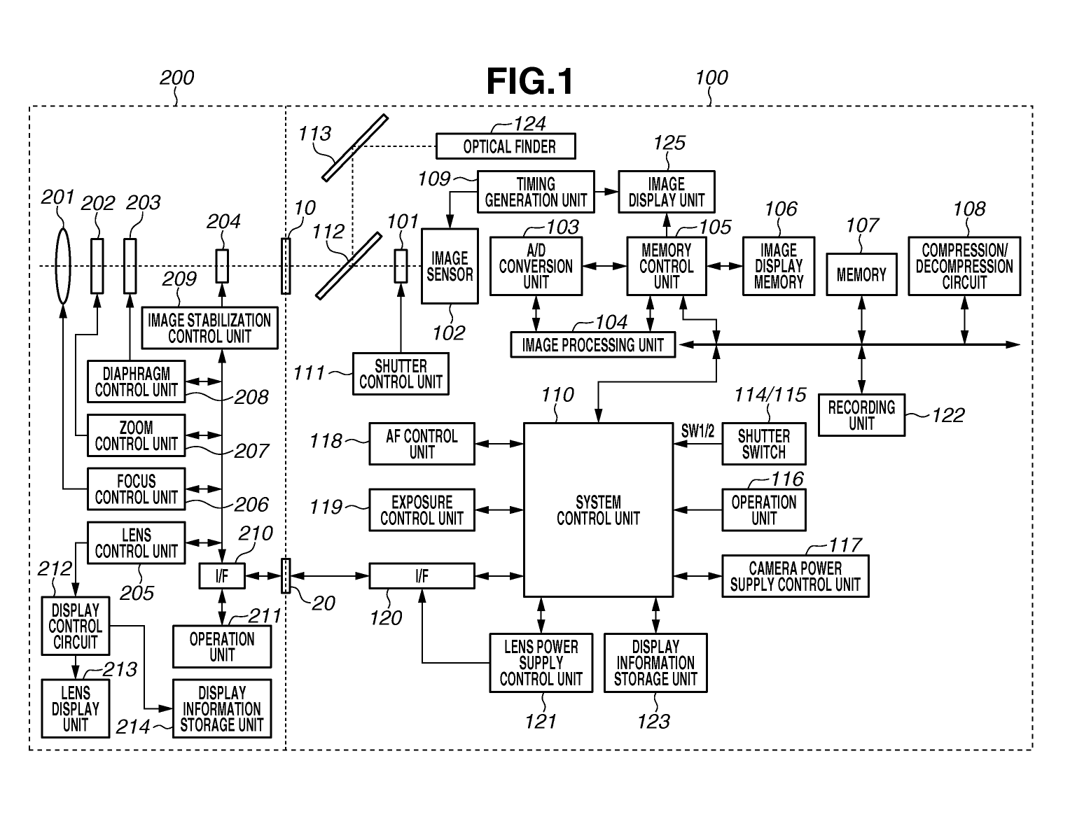

Exemplary embodiments of the present invention will be described in detail below based on the attached drawings. FIG. 1 is a diagram illustrating the configuration of a camera lens system according to an exemplary embodiment of the present invention.

With reference to FIG. 1, an interchangeable-lens camera system according to an exemplary embodiment of the present invention is described below.

As illustrated in FIG. 1, to a digital camera 100 according to a rendition of a present exemplary embodiment, a lens unit 200 is detachably attached via a lens mount unit 10. The lens unit 200, which can be attached to the digital camera 100, includes a photographing optical system including a focus lens 201, a zoom lens 202, and a diaphragm 203. Although FIG. 1 illustrates a single lens, a lens group including a plurality of lenses may be used. A ray of light incident through the photographing optical system is guided to an image sensor 102 and forms an optical image in the image sensor 102.

The image sensor 102 of the digital camera 100 (an imaging apparatus) converts the optical image of an object into an electric signal. A shutter 101 controls the amount of exposure for the image sensor 102. An analog-to-digital (A/D) conversion unit 103 converts an analog signal output from the image sensor 102 into a digital signal. A timing generation unit 109 supplies a clock signal and a control signal to a memory control unit 105 and a system control unit 110.

An image processing unit 104 performs a predetermined pixel interpolation process and a predetermined color conversion process on data from the A/D conversion unit 103 or data from the memory control unit 105, thereby generating image data. Further, the image processing unit 104 performs a predetermined calculation process using captured image data. Based on the obtained calculation result, the system control unit 110 notifies an exposure control unit 119 and an autofocus (AF) control unit 118, which performs AF control, of control commands, thereby achieving an automatic exposure (AE) process and an AF process.

The memory control unit 105 controls the A/D conversion unit 103, the timing generation unit 109, the image processing unit 104, an image display memory 106, a memory 107, and a compression/decompression circuit 108. Data output from the A/D conversion unit 103 is written in the image display memory 106 or the memory 107 via the image processing unit 104 and the memory control unit 105. An image display unit 125 includes a liquid crystal display (LCD). In the case of an electronic view finder (EVF), captured image data is sequentially displayed using an external display apparatus (not illustrated) or the image display unit 125, thereby achieving an EVF function. The memory 107 stores a photographed still image and a photographed moving image. The memory 107 is also used as a work area for the system control unit 110.

An object image formed by light passing through the photographing optical system can be observed through an optical finder 124 via mirrors 112 and 113 when the mirror 112 is down.

A shutter control unit 111 cooperates with a diaphragm control unit 208, which controls the diaphragm 203, to control the shutter 101, based on photometric information from the exposure control unit 119.

The AF control unit 118 performs an AF process. A ray of light is incident through the photographing optical system. The ray of light is incident on a focus detection unit in the AF control unit 118 via the mirror 112 and a sub-mirror (not illustrated) for focus detection by a single-lens reflex method. This enables the AF control unit 118 to perform AF control by a phase difference detection method, which measures the in-focus state of an image formed as an optical image in the focus detection unit. In the case of the EVF, the AF control unit 118 performs an AF process by a contrast method, which calculates the contrast component of image data generated by the image processing unit 104, thereby performing AF. Alternatively, in the case of the EVF, the AF control unit 118 may also perform an AF process by the phase difference detection method, which uses signals output from pixels for AF that are embedded in the image sensor 102.

The exposure control unit 119 performs an AE process. When the ray of light is incident through the photographing optical system, the ray of light is incident on a photometric unit in the exposure control unit 119 via the mirrors 112 and 113 by the single-lens reflex method, thereby obtaining photometric information, so that the exposure control unit 119 can measure the exposure state of an image formed as an optical image. In the case of the EVF, the system control unit 110 controls the exposure of an image generated by the image processing unit 104.

The exposure control unit 119 has a plurality of photometry modes and operates in one of the photometry modes set by a user through an operation unit 116. Examples of the photometry modes include an evaluation photometry mode for weighting any area in a screen, and an average photometry mode for averaging the brightness of the entirety of the screen to measure light, thereby controlling the amount of exposure.

The system control unit 110 is in charge of the control of the entirety of the digital camera 100 and executes a camera control program. If a shutter switch (SW1) 114 is operated, the system control unit 110 is given instructions to start the operations of an AF process, an AE process, and an automatic white balance (AWB) process. If a shutter switch (SW2) 115 is operated, the system control unit 110 performs an exposure process for writing a signal read from the image sensor 102 to the memory 107 via the A/D conversion unit 103 and the memory control unit 105. Further, according to the operation of the shutter switch SW2, the image processing unit 104 starts the operation of the process for recording image data. The generated image data is recorded in a recording unit 122 such as an external memory.

The operation unit 116 includes various buttons, a touch panel, and a power on/off button and outputs to the system control unit 110 an instruction received as a result of a user operation. Based on a user operation through the operation unit 116, it is possible to switch the above photometry mode between the average photometry mode and the evaluation photometry mode. The system control unit 110 receives an input operation through the operation unit 116 and switches between various photographing modes of the digital camera 100, such as a still image photographing mode and a moving image photographing mode. Alternatively, the system control unit 110 selects a special scene photographing mode such as a night view mode and performs camera control according to the operation of switching AF modes such as a servo AF mode.

According to the operation of the shutter switch SW1 or the operation unit 116, the system control unit 110 controls the AF control unit 118 to start an AF operation. Examples of the modes of the AF operation include a one-shot AF mode for starting the AF operation when the shutter switch SW1 is turned on, and a continuous AF mode for starting the AF operation before the shutter switch SW1 is turned on. Further, it is possible to switch between an AF frame fixing mode for limiting a focus target to a single area in the screen, an automatic selection mode for setting the entirety of the screen as a focus target, and a face detection mode for setting as a focus target a face which is detected if present in the screen.

An interface (I/F) 120 in the camera and an I/F 210 in the lens are interfaces for connecting the digital camera 100 and the lens unit 200. An electric signal is sent between the system control unit 110 in the digital camera 100 and a lens control unit 205 via a connector 20, whereby it is possible to transmit and receive control information and various types of data.

A lens power supply control unit 121 manages power to be supplied to the lens unit 200. If the system control unit 110 detects the attachment of the lens unit 200, the lens power supply control unit 121 supplies power to the lens. If the lens unit 200 is removed, the lens power supply control unit 121 disconnects the supply of power to the lens.

A camera power supply control unit 117 manages an external battery and a built-in battery. If a battery is removed, or if a battery runs out, the camera power supply control unit 117 performs an emergency camera control disconnection process. At this time, the lens power supply control unit 121 disconnects the supply of power to the lens unit 200. Further, if a power-off operation is performed through the operation unit 116, the system control unit 110 communicates, to the lens control unit 205, a request to switch the lens unit 200 to a low-consumption mode, via the I/F 120.

FIG. 1 illustrates a display information storage unit 123 as a memory area. In the present exemplary embodiment, however, the display information storage unit 123 is not an essential component and therefore is not described here. The display information storage unit 123 in the digital camera 100 will be described later in another exemplary embodiment.

Next, the internal configuration of the lens unit 200 is described. The diaphragm control unit 208 controls the diaphragm 203 using diaphragm control information obtained based on the result of calculation according to photometric information from the exposure control unit 119, or from the system control unit 110 when the EVF is used. The diaphragm control information is received from the system control unit 110 via the connector 20. A zoom control unit 207 controls the zoom lens 202. A focus control unit 206 controls the movement of the focus lens 201 based on focus control information received from the system control unit 110. The focus control information is generated by performing AF using the above phase difference detection method or the above contrast method. An image stabilization control unit 209 controls an image stabilization control lens 204.

The lens control unit 205 is in charge of the control of the entirety of the lens unit 200. The lens unit 200 according to the present exemplary embodiment includes a lens display unit 213 such as a liquid crystal member, which can switch display contents. A display control circuit 212 controls the on/off state of the display of the lens display unit 213 and the display of the lens display unit 213 at the start-up. The lens control unit 205 gives an instruction to the display control circuit 212. The lens unit 200 also includes an operation unit 211. The user performs an operation through the operation unit 211 and thereby can switch display information on the lens display unit 213.

The lens unit 200 also includes a display information storage unit 214, which is a non-volatile memory. Even if the supply of power to the lens unit 200 is disconnected, the display information storage unit 214 can store information for maintaining display information. In the present exemplary embodiment, the display information storage unit 214 stores display state information indicating a content displayed on the lens display unit 213 immediately before the supply of power to the lens unit 200 is disconnected.

At predetermined timing, the display control circuit 212 updates in the display information storage unit 214 the writing of display state information indicating a content displayed on the lens display unit 213 and also transmits the display state information to the lens control unit 205.

The lens control unit 205 includes a volatile memory (not illustrated) and stores, in the volatile memory, display state information transmitted from the display control circuit 212. Further, if a power-off request is detected from the system control unit 110, the lens control unit 205 causes a central processing unit (CPU) included in the lens control unit 205 to shift to the low-consumption mode. At this time, if information stored in the volatile memory is lost, the lens control unit 205 instructs the display control circuit 212 to store the latest display state information.

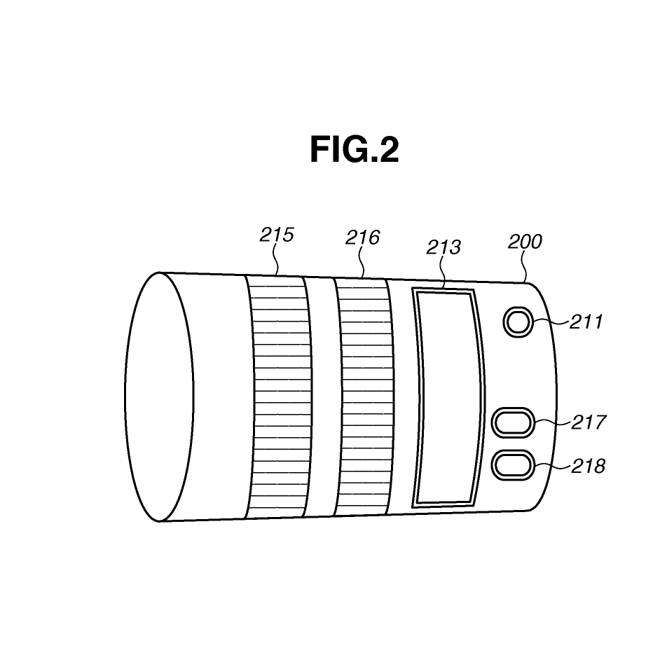

Next, with reference to FIG. 2, the configuration of the lens unit 200 according to the present exemplary embodiment is described. The lens unit 200 includes various operation members and a display member.

A zoom ring 215 is a member for manually operating a zoom mechanism of the lens unit 200. A focus ring 216 is a ring for manually operating a focus mechanism of the lens unit 200. The lens display unit 213 is a display member including a liquid crystal monitor and capable of variably switching its display contents. A member included in the lens display unit 213 is not limited to the liquid crystal monitor. Alternatively, for example, an organic electroluminescence (EL) display may be used. An autofocus/manual focus (AF/MF) switch 217 is used to switch between AF and MF using the focus ring 216.

An image stabilization switch 218 is a switch that allows the switching of the on/off state of image stabilization and also allows the switching between various image stabilization modes.

The operation unit 211 is a button switch for switching information displayed on the lens display unit 213. A member included in the operation unit 211 is not limited to the button switch. Alternatively, for example, the operation unit 211 may include a dial member.

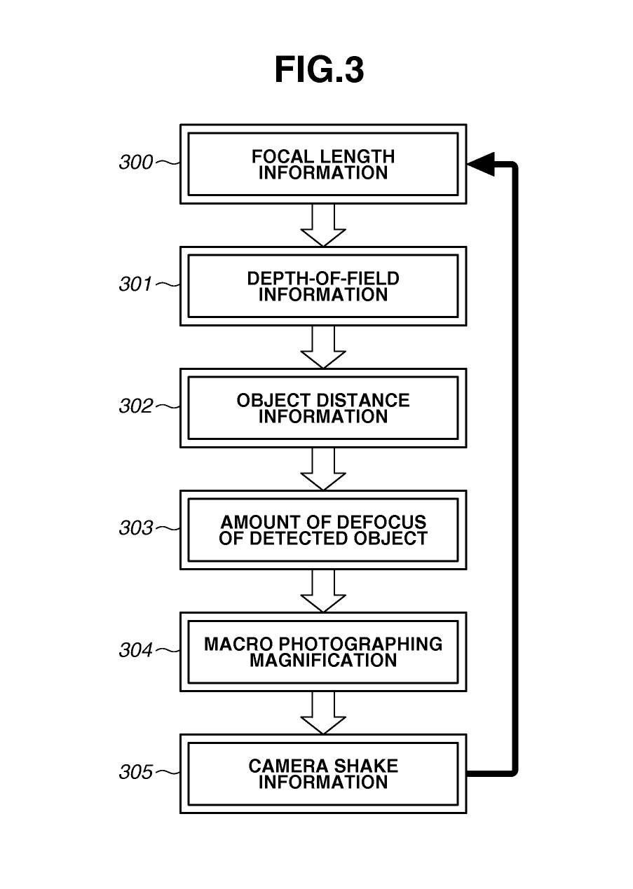

Next, FIG. 3 illustrates examples of display state information that can be switched and is displayed on the lens display unit 213 according to the present exemplary embodiment.

Display 300 presents a state where focal length information is displayed. The display 300 may provide graduations indicating the focal length, or may represent the numerical value of the focal length as a digital numerical value. Display 301 presents a state where depth-of-field information is displayed. For example, the display 301 presents graduations indicating the depth of field when the diaphragm 203 is set to F11, F16, or F22. Display 302 presents a state where object distance information is displayed. The display 302 presents the numerical value of the object distance.

Display 303 presents the amount of defocus of an object, which is obtained as a result of a focus detection process by the digital camera 100. The display 303 may indicate the degree of shift of focus by a scale, or by a numerical value. Display 304 presents the macro photographing magnification, when a macro function is used. Display 305 presents camera shake information. The display 305 presents the amount and the direction of detected camera shake. The display contents may be further switched according to the image stabilization modes set using the image stabilization switch 218. The switching between the display menus is performed according to an operation by the user through the operation unit 211.

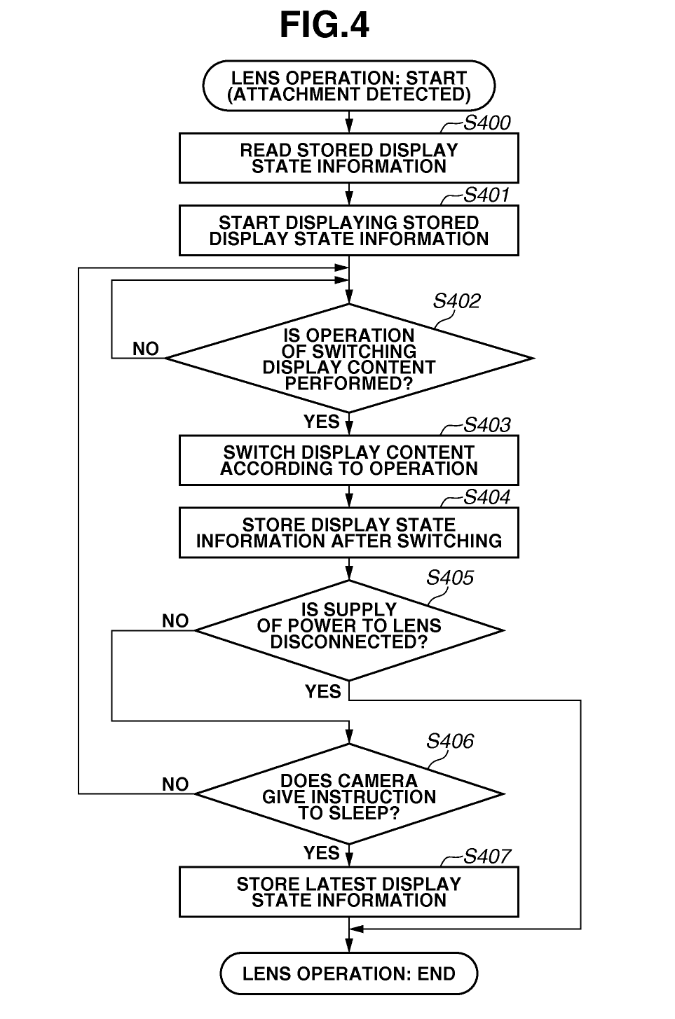

Next, with reference to FIG. 4, a description is given of the processing when the operation of the lens unit 200 is started in one rendition of the present exemplary embodiment. If the lens unit 200 is attached to the digital camera 100, or if the digital camera 100 is powered on, a lens operation is started, and the processing proceeds to step S400.

In step S400, the lens control unit 205 reads display state information stored in the display information storage unit 214. In step S401, the lens control unit 205 notifies the display control circuit 212 of the display state information read in step S400 and starts displaying the display state information as the initial display content of the lens display unit 213.

In step S402, the lens control unit 205 determines whether the operation of switching the display content has been performed through the operation unit 211. If the operation of switching the display content is detected (Yes in step S402), the processing proceeds to step S403. If the operation of switching the display content is not detected (No in step 402), the processing in step S402 is repeated.

In step S403, the lens control unit 205 indicates, to the display control circuit 212, information on the display content (display state information) after the switching according to the operation detected in step S402. In step S404, the lens control unit 205 stores in the display information storage unit 214 the display state information indicated to the display control circuit 212 in step S403.

In step S405, the lens control unit 205 determines whether the supply of power to the lens unit 200 is disconnected. If the supply of power is disconnected (Yes in step S405), all the operations of the lens unit 200 including the lens control unit 205 stop, and the lens operation ends. If the supply of power is not disconnected (No in step S405), the processing proceeds to step S406. The operation in this flowchart continues so long as power is supplied to the lens unit 200.

In step S406, the lens control unit 205 determines whether the system control unit 110 of the digital camera 100 gives, by communication via the I/F 120, an instruction to shift to a sleep state to save power. In the sleep state, the display of the lens display unit 213 is turned off. If an instruction to shift to the sleep state is given (Yes in step S406), the lens control unit 205 switches the CPU, which causes the lens control unit 205 to operate, to the sleep state. If an instruction to shift to the sleep state is not given (No in step S406), the processing returns to step S402. In step S407, the lens control unit 205 stores in the display information storage unit 214 the latest display state information before the CPU is put to sleep. Then, the lens control unit 205 switches a state of the CPU to the sleep state and turns off the display of the lens display unit 213. If the CPU returns from the sleep state, the process of step S400 is resumed, and the display of the lens display unit 213 is turned on.

As described above, in the present exemplary embodiment, the latest display state of the lens unit is stored in the display information storage unit on the lens side. Consequently, if the CPU of the lens unit shifts to a sleep state, when the CPU returns from the sleep state, it is possible to restore the display of the lens unit by maintaining the same menu as that of the previous display state.

Another embodiment of the present exemplary embodiments is described below. In the present exemplary embodiment, both the camera and the lens include components for storing display state information. When lenses are interchanged, the display state is restored using display state information stored in the camera or the lens.

With respect to the configurations of the digital camera 100 and the lens unit 200, portions similar to those of the previous exemplary embodiment are not described here. In FIG. 1, the display information storage unit 123 in the digital camera 100 is a memory area and stores the last (most recent) display state information displayed on the lens display unit 213.

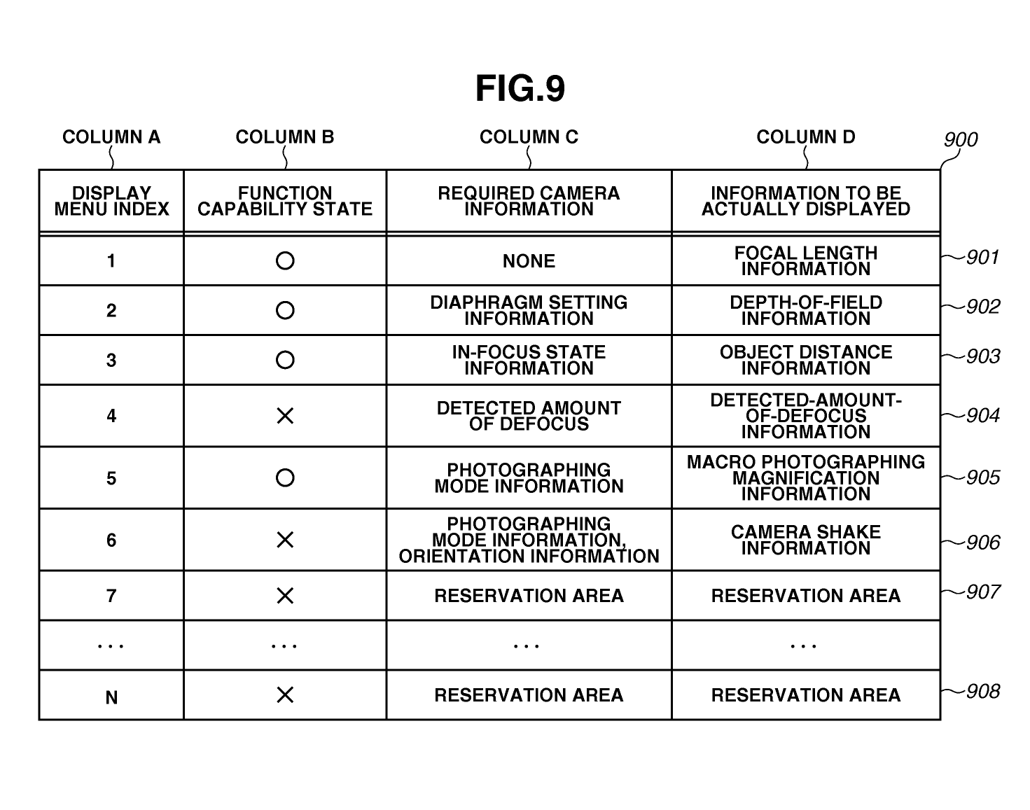

In the present exemplary embodiment, every time the display state of the lens is changed, information stored in the display information storage unit 123 on the camera side is also updated. If the lens control unit 205 detects a request from the system control unit 110 on the camera side to acquire display state information, the lens control unit 205 responds to the request by transmitting display state information stored in the volatile memory. As described in the previous exemplary embodiment, the camera and the lens communicate with each other via the connector 20, thereby exchanging display state information displayed on the lens display unit 213 and display state information to be restored for display. A data format in this communication will be described later with reference to FIG. 9.

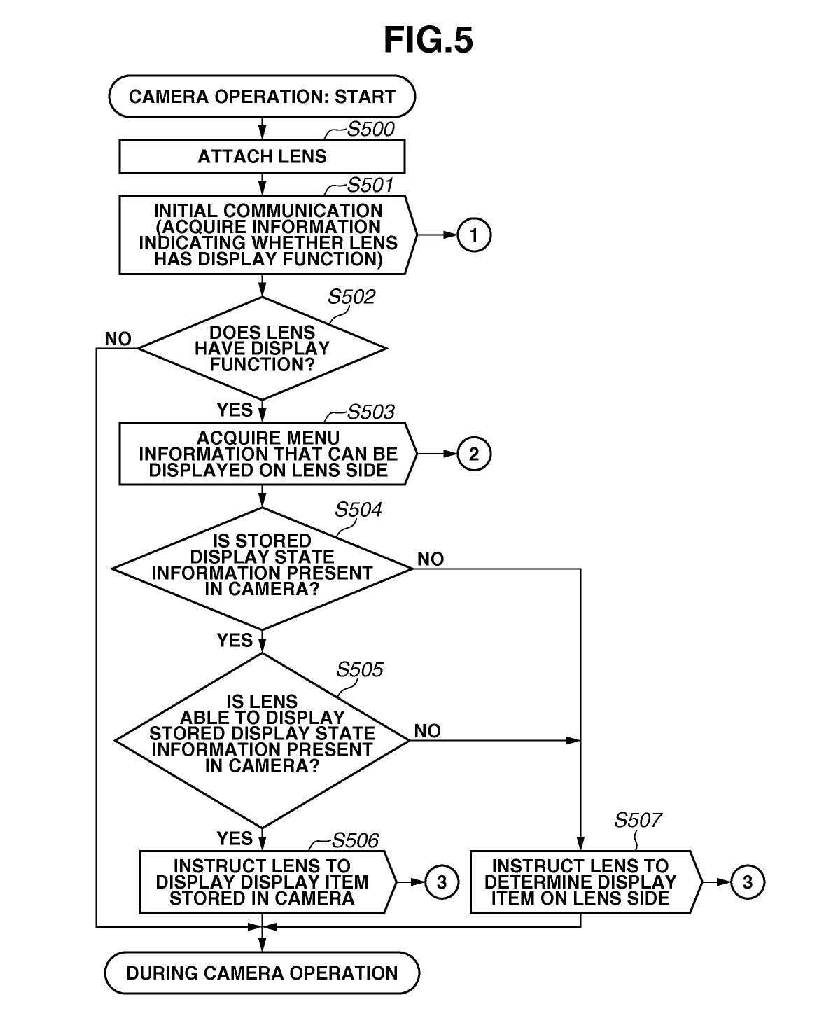

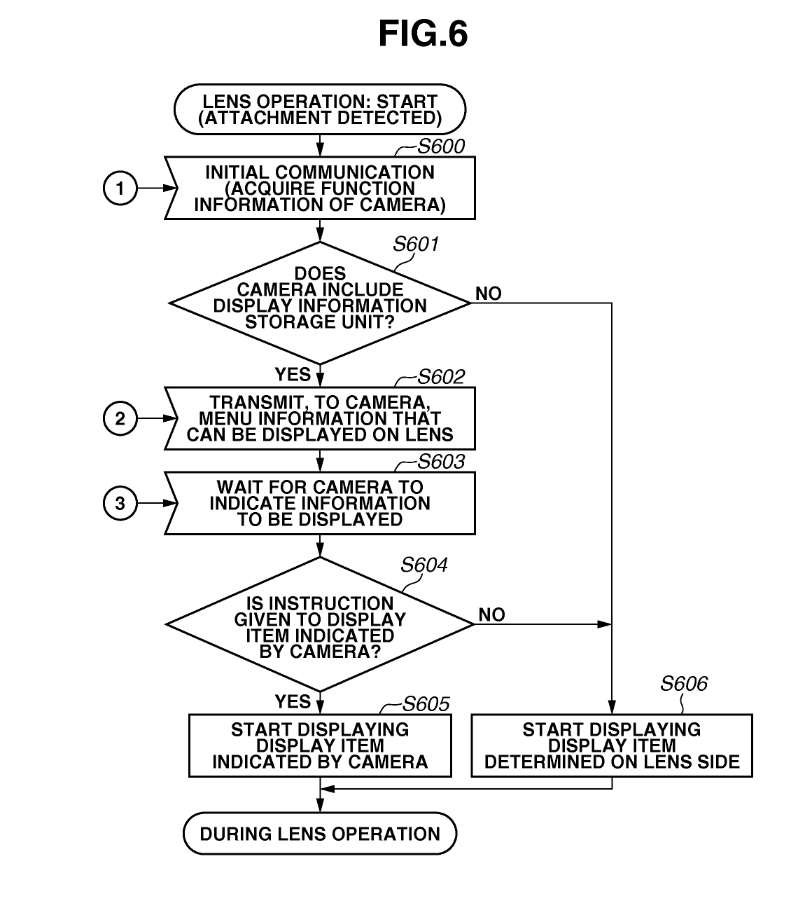

With reference to FIGS. 5 and 6, descriptions are given of the control flows of the digital camera 100 and the lens unit 200 when the digital camera 100 is started up (when the operation of the digital camera 100 is started).

First, with reference to FIG. 5, the control flow on the camera side is described. If the digital camera 100 is started up, the processing proceeds to step S500. In step S500, the system control unit 110 confirms the attachment of the lens unit 200.

In step S501, the system control unit 110 performs initial communication with the lens unit 200. In the initial communication, the digital camera 100 transmits function information held in the digital camera 100 to the lens unit 200 and receives function information held in the lens unit 200. When this process is performed, both the camera and the lens share corresponding function information.

In the present exemplary embodiment, the lens control unit 205 transmits to the digital camera 100 information indicating whether the lens unit 200 has a display function (whether the lens unit 200 includes the lens display unit 213) as a piece of function information. Further, the system control unit 110 notifies the lens control unit 205 of information indicating whether the digital camera 100 includes a unit (the display information storage unit 123) for storing display state information displayed on the lens display unit 213. The process of step S501 corresponds to the process of step S600 in FIG. 6.

In step S502, based on the information acquired from the lens control unit 205 in the initial communication in step S501, the system control unit 110 determines whether the lens unit side has the display function (whether the lens unit side includes the lens display unit 213). Only if the lens unit side has the display function (Yes in step S502), does the processing proceed to step S503. If the lens unit side does not have the display function (No in step S502), the processing in the flowchart is terminated.

In step S503, the system control unit 110 requests the lens control unit 205 to list information on display state information (menu information) that can be displayed on the lens unit side, thereby acquiring the information. The format of the display menu information acquired in this step will be described later with reference to FIG. 9. The process of step S503 corresponds to the process of step S602 in FIG. 6.

In step S504, the system control unit 110 determines whether stored display state information is present in the display information storage unit 123 in the digital camera 100. If stored display state information is not present (No in step S504), the processing proceeds to step S507. If stored display state information is present (Yes in step S504), the processing proceeds to step S505.

In step S505, the system control unit 110 compares the list of display state information that can be displayed on the lens unit side, which is acquired from the lens control unit 205 in step S503, with the display state information stored in the digital camera 100, which is determined in step S504. Then, the system control unit 110 determines whether the display state information stored in the digital camera 100 is included in the list acquired from the lens control unit 205. In other words, the system control unit 110 determines whether the lens unit side can display the display state information stored in the digital camera 100. If the display state information stored in the digital camera 100 is included in the list acquired from the lens control unit 205 (Yes in step S505), the processing proceeds to step S506. If the display state information stored in the digital camera 100 is not included (No in step S505), the processing proceeds to step S507.

If the processing proceeds to step S506, the lens unit 200 can display an item of the display state information stored in the digital camera 100. Then, the system control unit 110 communicates to the lens control unit 205 information indicating the display state information stored in the digital camera 100 and instructs the lens control unit 205 to start displaying on the lens display unit 213 the display state indicated by the communicated information.

If, on the other hand, the processing proceeds to step S507, the lens unit 200 cannot display an item of the display state information stored in the digital camera 100. Therefore, the system control unit 110 instructs, by communication, the lens control unit 205 to start displaying display state information determined on the lens unit side. In this case, the lens control unit 205 may start displaying display state information stored in the display information storage unit 214 on the lens unit side, or may start displaying a default screen. The processes of steps S506 and S507 both correspond to the process of step S603 in FIG. 6.

Next, with reference to FIG. 6, a description is given of the control flow of the lens unit 200, which corresponds to the above control flow of the digital camera 100. Referring to FIG. 6, if power is supplied to the lens unit 200 by, for example, attaching the lens unit 200 to the digital camera 100, the processing proceeds to step S600.

In step S600, the lens control unit 205 performs initial communication with the system control unit 110 of the digital camera 100. This enables the lens control unit 205 to transmit to the digital camera 100 information indicating whether the lens unit 200 includes the lens display unit 213 and receive information indicating whether the digital camera 100 includes the display information storage unit 123 for storing display state information of the lens unit 200.

In step S601, based on the information received in step S600, the lens control unit 205 determines whether the attached digital camera 100 includes a storage unit (the display information storage unit 123) capable of storing display state information of the lens. If the digital camera 100 includes the display information storage unit 123 (Yes in step S601), the processing proceeds to step S602. If the digital camera 100 does not include the display information storage unit 123 (No in step S601), the processing proceeds to step S606.

In step S602, the lens control unit 205 receives a communication request from the digital camera 100 and transmits to the digital camera 100 list information of display state information that can be displayed on the lens display unit 213. After the transmission of the list information, then in step S603, the lens control unit 205 waits for the digital camera 100 to indicate information to be displayed on the lens display unit 213. At this time, display state information stored in the digital camera 100 (step S506) or display state information determined on the lens unit side (step S507) is indicated.

In step S604, the lens control unit 205 determines information indicated by the digital camera 100 in step S603. If display state information stored in the digital camera 100 is instructed (Yes in step S604), the processing proceeds to step S605. In step S605, the lens control unit 205 starts displaying on the lens display unit 213 the display state information indicated by the digital camera 100. If, on the other hand, an instruction is given to determine information to be displayed on the lens unit side (No in step S604), the processing proceeds to step S606. In step S606, the lens control unit 205 starts displaying on the lens display unit 213 display state information stored in the display information storage unit 214 on the lens side or default information determined in advance.

According to the above control flows, when a camera operation is started, control is performed to determine whether to start displaying on the lens display unit 213 information stored in the digital camera 100 or start displaying information stored on the lens unit side.

With reference to FIG. 9, a description is given of the format of the list of display state information that can be displayed on the lens unit side, which is communicated in steps S503 and S602. A table 900 illustrates an example of the format of the list of display state information that can be displayed on the lens unit side.

The list of display state information that can be displayed includes columns A, B, and C described in the table 900. A column D is added for ease of description and does not need to be directly transmitted and received between the system control unit 110 and the lens control unit 205. Pieces of information 901 to 906 described in the column D illustrate all items that can be actually displayed on the lens display unit 213 in a group of interchangeable lens products.

The column A manages the items described in the column D using an index. The column B indicates whether a certain interchangeable lens product has the function of displaying each piece of display information described in the column D. In the example of FIG. 9, it is indicated that the focal length information 901 can be displayed, but the camera shake information 906 cannot be displayed. In the column B, items with “o” correspond to menu items that are illustrated in the display 300 to 305 in FIG. 3 and can be displayed on the lens display unit 213. Further, reservation areas 907 and 908 are provided for future extensions. If a new display item is created in a lens in the future, these reservation areas can be used.

The column C indicates information on the camera side that is required to display on the lens display unit 213 the display information described in the column D. In a case of displaying the depth-of-field information 902, for example, it is indicated that diaphragm setting information on the camera side is required to acquire the depth-of-field information 902.

In the process of communication in steps 5503 and S602, the lens control unit 205 notifies the system control unit 110 on the camera side of table information of the columns A, B, and C. Then, in step S504, to determine whether stored display state information is present in the digital camera 100, the display menu index information is stored in the display information storage unit 123 in the digital camera 100 using the format described in FIG. 9. The items and the data format of information that can be displayed and is transmitted from the lens unit side are not limited to those in the example of FIG. 9.

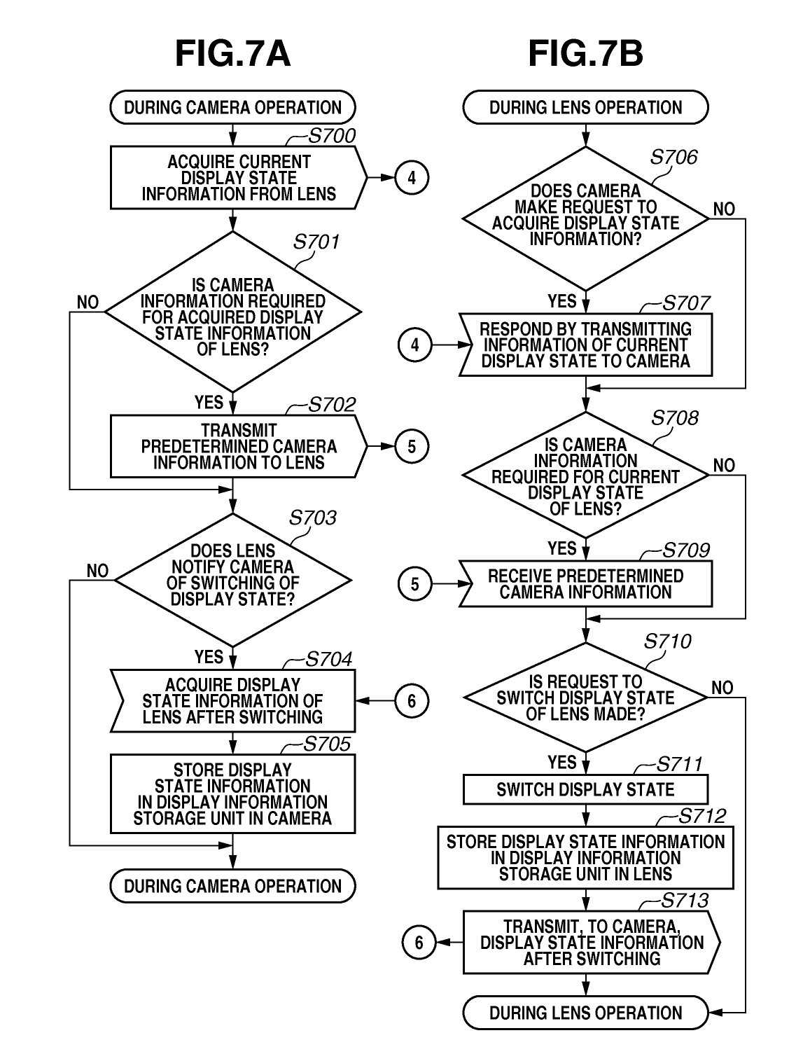

Next, with reference to FIGS. 7A and 7B, descriptions are given of the control flows of both the digital camera 100 and the lens unit 200 when lens display information is switched during the operations of the digital camera 100 and the lens unit 200. FIG. 7A illustrates the control flow during the operation on the camera side. FIG. 7B illustrates the control flow during the operation on the lens unit side.

First, referring to FIG. 7A, after the digital camera 100 is started up, then in step S700, the system control unit 110 acquires, from the lens control unit 205 by communication, information indicating the current display state on the lens display unit 213. The information to be communicated in this step is represented using the display menu index in the format described in FIG. 9. The process of step S700 corresponds to the process of step S707 in FIG. 7B.

In step S701, the system control unit 110 determines whether there is required camera information (information in the column C in the format of FIG. 9) corresponding to the display menu index acquired in step S700. If there is camera information required on the lens unit side (Yes in step S701), the processing proceeds to step S702. If there is not camera information required on the lens unit side (No in step S701), the processing proceeds to step S703.

In step S702, the system control unit 110 transmits to the lens control unit 205, predetermined camera information which is determined to be required. The process of step S702 corresponds to the process of step S709 in FIG. 7B.

In step S703, the system control unit 110 determines whether the lens control unit 205 notifies the system control unit 110 of the switching of the display state. If it is determined that any switching has been performed (Yes in step S703), the processing proceeds to step S704. If it is determined that switching has not been performed (No in step S703), the processing is terminated. In step S704, the system control unit 110 acquires, from the lens control unit 205, display state information after the switching. The process of step S704 corresponds to the process of step S713 in FIG. 7B.

In step S705, the system control unit 110 stores in the display information storage unit 123 the display state information acquired in step S704.

Next, with reference to FIG. 7B, a description is given of the control flow on the lens unit side, which corresponds to the control flow on the camera side in FIG. 7A.

First, in step S706, the lens control unit 205 determines whether the system control unit 110 on the camera side makes a request to acquire display state information. If the camera side makes an acquisition request (Yes in step S706), the processing proceeds to step S707. If the camera side does not make an acquisition request (No in step S706), the processing proceeds to step S708. In step S707, the lens control unit 205 responds to the request by transmitting, to the system control unit 110 on the camera side, display state information currently displayed on the lens display unit 213.

In step S708, the lens control unit 205 determines whether information on the camera side is required for the display state information currently displayed on the lens display unit 213. Specifically, the lens control unit 205 references the column C in the table in FIG. 9 and determines whether there is information to be required. If it is determined that information on the camera side is required for the display of the lens unit 200 (Yes in step S708), the processing proceeds to step S709. If it is determined that information on the camera side is not required (No in step S708), the processing proceeds to step S710. In step S709, the lens control unit 205 receives predetermined camera information (information in the column C in FIG. 9) transmitted from the digital camera 100.

In step S710, the lens control unit 205 determines whether a request to switch the display state has been made by an operation through the operation unit 211. If a request to switch the display state of the lens has been made (Yes in step S710), the processing proceeds to step S711. If a request to switch the display state of the lens has not been made (No in step S710), the processing is terminated. In step S711, the lens control unit 205 switches the display state of the lens display unit 213. Further, the lens control unit 205 notifies the system control unit 110 that the display state is switched.

Next, in step S712, the lens control unit 205 stores, in the display information storage unit 214 in the lens unit 200, display state information obtained by switching the display state in step S711. In step S713, the lens control unit 205 transmits, to the system control unit 110 on the camera side, the display state information obtained by switching the display state in step S711.

As described above, in the exemplary embodiments, if the display state of the lens display unit 213 is switched through the operation unit 211, display state information obtained by switching the display state is stored in the display information storage unit 214 on the lens side, and the latest display state information is transmitted to the camera side.

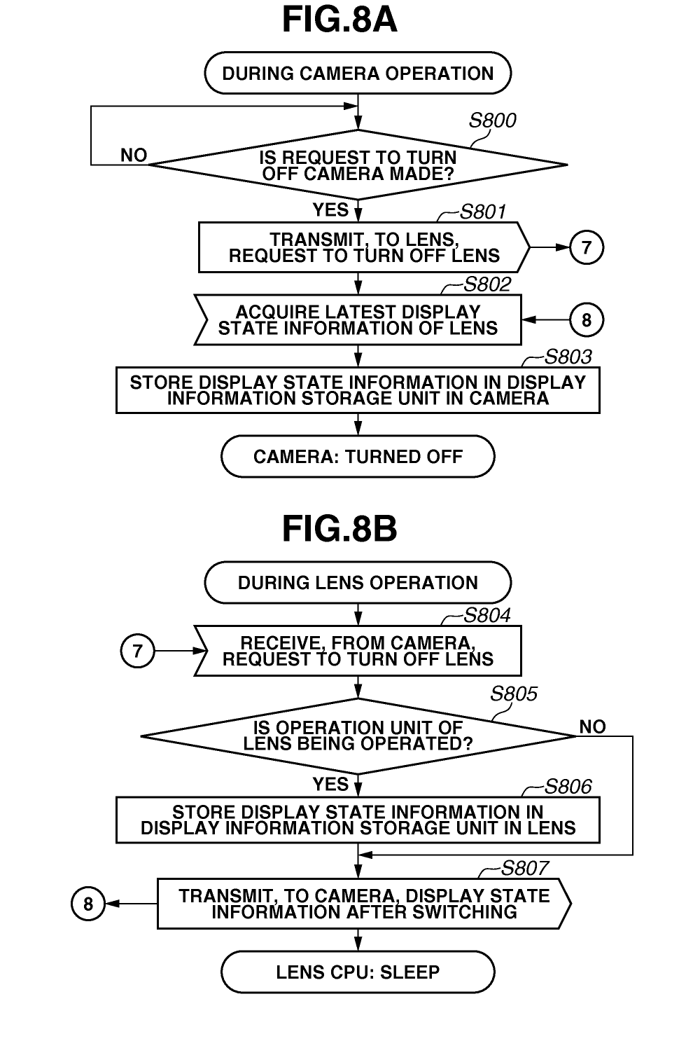

Next, with reference to FIGS. 8A and 8B, descriptions are given of the control flows of both the digital camera 100 and the lens unit 200 in a case where lens display information is switched when the digital camera 100 is powered off. FIG. 8A illustrates the control flow during the operation on the camera side. FIG. 8B illustrates the control flow during the operation on the lens unit side.

First, referring to FIG. 8A, in step S800, the system control unit 110 determines whether a request to power off the digital camera 100 has been made by a user operation. If a request to power off the digital camera 100 has been made (Yes in step S800), the processing proceeds to step S801. If a request to power off the digital camera 100 has not been made (No in step S800), the processing in step S800 is repeated. In step S801, the system control unit 110 transmits to the lens control unit 205 a request to power off the lens. The process of step S801 corresponds to the process of step S804 in FIG. 8B.

In step S802, the system control unit 110 acquires the last display state information transmitted from the lens control unit 205. The process of step S802 corresponds to the process of step S807 in FIG. 8B.

In step S803, the system control unit 110 stores, in the display information storage unit 123 in the digital camera 100, the display state information acquired in step S802 and power off the digital camera 100.

Next, with reference to FIG. 8B, a description is given of the control flow on the lens unit side, which corresponds to the control flow on the camera side in FIG. 8A.

First, in step S804, the lens control unit 205 receives, from the system control unit 110 on the camera side, a request to power off the lens. If a request to power off the lens is received, the processing proceeds to step S805. In step S805, the lens control unit 205 determines whether the operation unit 211 is operated. If the operation unit 211 is operated (Yes in step S805), the processing proceeds to step S806. If the operation unit 211 is not operated (No in step S805), the processing proceeds to step S807.

In step S806, the lens control unit 205 stores, in the display information storage unit 214 in the lens, update information on the display state. In step S807, the lens control unit 205 transmits the latest display state information (the last display state information) to the digital camera 100. In this step, if the display state is switched in step S805, the lens control unit 205 transmits, to the digital camera 100, display state information obtained by switching the display state. Then, the lens control unit 205 causes the CPU to shift to a sleep state.

Alternatively, in step S805, only in a case where the display state is switched through the operation unit 211, the latest display state information may be sent from the lens side to the camera side in step S807.

As described above, if the digital camera 100 is powered off in the middle of switching the display state of the lens display unit 213 through the operation unit 211, the latest display state information is stored in the display information storage units on the lens side and the camera side. During the operations of the digital camera 100 and the lens unit 200, the control flows in FIGS. 7A and 7B are repeated. If the digital camera 100 is powered off, the control flows in FIGS. 8A and 8B are performed.

For example, it is assumed that a camera A, which includes the display information storage unit 123, is powered off in a state where a lens A, which includes the lens display unit 213, is attached to the camera A, and the lens A is replaced with a lens B, which also includes the lens display unit 213. In this case, when the camera A is powered off, the display information storage unit 123 in the camera A stores the last display state information of the lens A. Then, if the lens B is attached to the camera A and the camera A is powered on, the camera A receives from the lens B a list of display state information that can be displayed. If the display state information stored in the camera A is included in the list received from the lens B, the display state information stored in the camera A is displayed on the lens B. If, on the other hand, the display state information stored in the camera A is not included in the list received from the lens B, display state information determined by the lens B is displayed on the lens B.

As described above, in the exemplary embodiments, the latest display state of the lens unit is stored in the display information storage units on both the lens side and the camera side. Consequently, when the lens unit is detached from the camera, even if a lens different from that before the detachment is attached, it is possible to maintain a menu state to be displayed so long as the lens has the function of displaying the same state information as that of the lens before the detachment.

While the exemplary embodiments of the present invention have been described, the present invention is not limited to a device directed mainly to photographing, such as a video camera, and is applicable to any device with a built-in or externally connected focus adjustment apparatus, such as a mobile phone, a personal computer (a laptop computer, a desktop computer, and a tablet computer), and a game apparatus. Thus, an “imaging apparatus” in the specification is intended to include any electronic device having an imaging function.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-208409, filed Oct. 9, 2014, which is hereby incorporated by reference herein in its entirety.

What is claimed is:

1. A lens unit that can be attached to an imaging apparatus, the lens unit comprising:
a display unit configured to switch and display information relating to a plurality of items;
a lens control unit configured to control the display on the display unit; and
a first storage unit configured to store first information indicating an item selected from among items of information that can be displayed on the display unit,
wherein, when the display on the display unit is turned off, the lens control unit stores in the first storage unit the first information corresponding to an item of information displayed on the display unit, and when the display on the display unit is turned on, the lens control unit displays, on the display unit, information relating to the item indicated by the first information stored in the first storage unit.

2. The lens unit according to claim 1, wherein, in a case where items of information displayed on the display unit are switched, the lens control unit displays, on the display unit, information corresponding to the item after the switching, and stores in the first storage unit the first information corresponding to the item after the switching.

3. A lens unit that can be attached to an imaging apparatus, the lens unit comprising:
a display unit configured to switch and display information relating to a plurality of items;
a lens control unit configured to exchange information in communication with the imaging apparatus and control the display on the display unit; and
a first storage unit configured to store first information indicating an item selected from among items of information that can be displayed on the display unit,
wherein, based on information received from the imaging apparatus, the lens control unit switches between display and non-display, on the display unit, of information relating to the item corresponding to the first information stored in the first storage unit.

4. The lens unit according to claim 3, wherein the lens control unit switches between a first display mode and a second display mode based on the information received from the imaging apparatus, and
wherein, in the first display mode, information corresponding to an item indicated by the imaging apparatus is displayed on the display unit, and, in the second display mode, the information relating to the item corresponding to the first information stored in the first storage unit is displayed on the display unit.

5. The lens unit according to claim 3, wherein, in a case where the lens control unit receives from the imaging apparatus a request for the first information, the lens control unit transmits to the imaging apparatus the first information corresponding to an item of information displayed on the display unit.

6. The lens unit according to claim 3, wherein, in a case where items of information displayed on the display unit are switched, the lens control unit displays, on the display unit, information corresponding to the item after the switching and stores in the first storage unit the first information indicating the item after the switching.

7. The lens unit according to claim 3, wherein, in a case where the lens control unit receives from the imaging apparatus a notification that the imaging apparatus is to be turned off, the lens control unit stores in the first storage unit the first information corresponding to an item of information displayed on the display unit.

8. The lens unit according to claim 3, wherein information received from the imaging apparatus in communication performed when the imaging apparatus is started up includes information indicating whether the imaging apparatus includes a second storage unit for storing the first information.

9. The lens unit according to claim 8, wherein, in a case where the lens control unit receives information indicating that the imaging apparatus does not include the second storage unit, the lens control unit displays, on the display unit, the information relating to the item corresponding to the first information stored in the first storage unit.

10. The lens unit according to claim 8, wherein, in a case where the lens control unit receives information indicating that the imaging apparatus includes the second storage unit, the lens control unit transmits, to the imaging apparatus, second information indicating an item of information that can be displayed on the display unit.

11. The lens unit according to claim 10, wherein, based on an instruction transmitted from the imaging apparatus according to the second information, the lens control unit switches the information displayed on the display unit, between the information relating to the item corresponding to the first information stored in the first storage unit and the information relating to the item corresponding to the first information stored in the second storage unit in the imaging apparatus.

12. The lens unit according to claim 11, wherein, in a case where the item indicated by the first information stored in the second storage unit in the imaging apparatus corresponds to the second information, the lens control unit receives from the imaging apparatus the first information stored in the second storage unit and displays, on the display unit, the information relating to the item corresponding to the received first information.

13. The lens unit according to claim 11, wherein, in a case where the item indicated by the first information stored in the second storage unit in the imaging apparatus does not correspond to the second information, the lens control unit displays, on the display unit, the information relating to the item corresponding to the first information stored in the first storage unit.

14. The lens unit according to claim 3, wherein the lens control unit transmits the first information to the imaging apparatus, receives, from the imaging apparatus, third information required to acquire the information relating to the item indicated by the first information, and, based on the received third information, acquires information to be displayed on the display unit.

15. An imaging apparatus to which a lens unit including a display unit configured to switch and display information relating to a plurality of items can be attached, the imaging apparatus comprising:
a control unit configured to exchange information in communication with the lens unit and transmit to the lens unit an instruction regarding display on the display unit; and
a second storage unit configured to store information received from the lens unit,
wherein the control unit receives, from a lens unit attached to the imaging apparatus, first information indicating an item selected from among items of information that can be displayed on the display unit, and stores the received first information in the second storage unit, and
wherein the control unit transmits, to a lens unit attached to the imaging apparatus, the instruction regarding the display on the display unit based on the first information stored in the second storage unit.

16. The imaging apparatus according to claim 15, wherein the control unit receives, from the lens unit, second information indicating an item of information that can be displayed on the display unit, and transmits to the lens unit the instruction regarding the display on the display unit based on the first information stored in the second storage unit and the received second information.

17. The imaging apparatus according to claim 16, wherein, in a case where the item indicated by the first information stored in the second storage unit corresponds to the received second information, the control unit instructs the lens unit to display, on the display unit, information relating to the item indicated by the first information stored in the second storage unit.

18. The imaging apparatus according to claim 16, wherein, in a case where the item indicated by the first information stored in the second storage unit does not correspond to the received second information, the control unit instructs the lens unit to determine an item of information to be displayed on the display unit.

19. The imaging apparatus according to claim 15, wherein, in communication performed with the lens unit when the imaging apparatus is started up, the control unit transmits, to the lens unit, information indicating that the imaging apparatus includes the second storage unit.

20. The imaging apparatus according to claim 15, wherein the control unit transmits, to the lens unit, third information required in acquiring information relating to the item indicated by the first information received from the lens unit.

21. The imaging apparatus according to claim 15, wherein, in a case where the lens unit notifies the control unit that items of information displayed on the display unit are switched, the control unit receives from the lens unit the first information corresponding to the item after the switching and stores the received first information in the second storage unit.

22. The imaging apparatus according to claim 15, wherein, in a case where the control unit transmits to the lens unit a notification that the imaging apparatus is to be turned off, the control unit receives from the lens unit the first information corresponding to an item of information displayed on the display unit and stores the received first information in the second storage unit.

23. A method for controlling a lens unit that can be attached to an imaging apparatus and includes a display unit configured to display information and a first storage unit, the method comprising:
switching and displaying, on the display unit, information relating to a plurality of items; and
storing, in the first storage unit, first information indicating an item selected from among items of information that can be displayed on the display unit,
wherein, when the display on the display unit is turned off, the first information corresponding to an item of information displayed on the display unit is stored in the first storage unit, and, when the display on the display unit is turned on, information relating to the item indicated by the first information stored in the first storage unit is displayed on the display unit.

24. A method for controlling a lens unit that can be attached to an imaging apparatus and includes a display unit configured to display information and a first storage unit, the method comprising:
exchanging information in communication with the imaging apparatus;
switching and displaying, on the display unit, information relating to a plurality of items; and
storing, in the first storage unit, first information indicating an item selected from among items of information that can be displayed on the display unit,
wherein, based on information received from the imaging apparatus, switching display and non-display, on the display unit, information relating to the item corresponding to the first information stored in the first storage unit is performed.

25. A method for controlling an imaging apparatus to which a lens unit including a display unit configured to switch and display information relating to a plurality of items can be attached and includes a second storage unit, the method comprising:
exchanging information in communication with the lens unit and transmitting to the lens unit an instruction regarding display on the display unit; and
storing, in the second storage unit, information received from the lens unit,
wherein first information indicating an item selected from among items of information that can be displayed on the display unit is received from a lens unit attached to the imaging apparatus, and the received first information is stored in the second storage unit, and
wherein the instruction regarding the display on the display unit based on the first information stored in the second storage unit is transmitted to a lens unit attached to the imaging apparatus.
